(19) United States
(12) Patent Application Publication
(10) Pub. No.: US 2004/0040158 A1
(43) Pub. Date: Mar. 4, 2004

(54) Cable cutter

(76) Inventor: Terence G. Stalder, Cleveland, OH (US)

Correspondence Address: TREXLER, BUSHNELL, GIANGIORGI,, BLACKSTONE & MARR, LTD., 105 WEST ADAMS STREET, SUITE 3600, CHICAGO, IL, 60603, US

(21) Appl. No.: 10/229,704

(22) Filed: Aug. 28, 2002

(51) Int. Cl. B26B 13/00

(52) U.S. Cl. 30/90.1; 30/92; 30/249

(57) ABSTRACT

A tool for use in cutting cable, preferably ACSR cable, includes first and second blades having cutting configurations. The first and second blades are pivotally connected and a handle are attached to each blade. Movement of the handles rotates the blades about the pivot point. Cable positioned between the cutting configurations is systematically cut by the cutting configurations as the blades are rotated toward each other. Each cutting configuration includes first and second sharp edges and a blunt edge positioned therebetween which defines a concave recess. The first and second sharp edges are used to cut the aluminum strands surrounding the steel cable. During the cutting of the aluminum strands, the steel portion of the cable is urged into the concave recess defined by the blunt edges. The steel cable is then sheared using the blunt edges.

### BACKGROUND OF THE INVENTION

The present invention relates to a cable cutter for cutting cables. More specifically, the present invention relates to a cable cutter having a blade configuration which enables the cable cutter to efficiently and effectively cut aluminum cable steel reinforced (“ACSR”) cable.

Cables commonly used in the electrical industry are typically formed of copper and/or aluminum and may be of the type which are solid or stranded. Prior art cable cutters, with the application of sufficient manual force, serve adequately to cut the copper and/or aluminum cables. It has been found, however, that these prior art cable cutters do not adequately cut cables formed of materials harder than copper or aluminum, such as steel. Thus, persons using such cable cutters may also find it necessary to have another cable cutter which is specifically designed for cutting steel.

The use of ACSR cable has been increasing in the electrical industry. ACSR cable includes one or more center reinforcing steel strands which are surrounded by outer strands of softer metal, such as aluminum. Both of the prior art cable cutters discussed above are inadequate for cutting ACSR cable; the cable cutters made for aluminum and/or copper are inappropriate or ineffective in cutting steel while the cable cutters made for steel would crush or otherwise damage copper or aluminum cables beyond the point at which the cut ends are useful.

Therefore, an improved cutter for cutting ACSR cables is needed, which can also cut cables formed of aluminum and/or copper, as well as cables formed of steel. The present invention provides such a cutter. Features and advantages of the present invention will become apparent upon a reading of the attached specification, in combination with a study of the drawings.

### OBJECTS AND SUMMARY OF THE INVENTION

A primary object of the invention is to provide a tool which is capable efficiently and effectively cutting ACSR cable using manual force.

An object of the invention is to provide a tool which is capable of efficiently and effectively cutting cables made of softer material, such as aluminum or copper, using manual force, and which is capable of efficiently and effectively cutting cables made of harder, material, such as steel, using manual force.

Another object of the invention is to provide a tool which has sharp edges for cutting cables made of soft material, such as aluminum or copper.

Another object of the invention is to provide a tool which has blunt edges for cutting cables made of hard material, such as steel.

Yet another object of the invention is to provide a tool having blunt edges having a small radius to nearly match the diameter of a center steel core of ACSR cable and entrap it in near perfect circle to provide a shearing action.

An object of the invention is to provide a tool having opposite blades which are moved toward one another to cut cable preferably by the movement of handles attached to the blades, but which could also be moved toward one another by other mechanisms such as a ratchet and pawl, by a hydraulic ram and hydraulic pump, or a driven pinion and gear mechanism.

Still another object of the invention is to provide a tool having cutting configurations which allow for the outer aluminum stranded configuration of ACSR cable to be cut prior to the harder central steel core of the ACSR cable being cut, which reduces the required force to make the cut.

Another object of the invention is to provide a tool having cutting configurations which do not allow the harder central steel core of ACSR cable to be cut by the sharp edges of the blade members, which are designed to cut the softer outer aluminum stranded configuration of the ACSR cable, thus preventing the dulling of the sharp edges of the blade members which reduces the wear life of the sharp edges.

Briefly, and in accordance with the foregoing, a tool having an improved cutting edge configuration for use with ACSR cable is provided. The tool includes a first blade having a cutting configuration and a second blade having a cutting configuration. A pivot point connects the first and second blades. A handle is attached to the first blade and a handle is attached to the second blade. Movement of the handles rotates the blades about the pivot point. Cable positioned between the cutting configurations is systematically cut by the cutting configurations as the blades are rotated toward each other. The cutting configurations are mirror images of each other. Each cutting configuration includes a first sharp edge and a second sharp edge. Positioned between the sharp edges is a blunt edge defining a concave recess. The first and second sharp edges are used to cut the aluminum strands surrounding the steel cable. During the cutting of the aluminum strands, the steel portion of the ACSR cable is urged into the concave recess of the blunt edges of the cutting configurations. Thus, the sharp edges are not used to cut the steel. Instead, the steel is fractured or severed using the generally blunt edges. In this manner, the sharp edges are preserved for cutting the softer aluminum material. Since the blunt edges are already blunt, they do not lose their edge when cutting the steel.

### BRIEF DESCRIPTION OF THE DRAWINGS

The features of the present invention which are believed to be novel are described in detail hereinbelow. The organization and manner of the structure and operation of the invention, together with further objects and advantages thereof, may best be understood by reference to the following description taken in connection with the accompanying drawings wherein like reference numerals identify like elements in which:

FIG. 1 is a front elevational view of a cable cutter of the present invention;

FIG. 2 is a cross-sectional side view showing a cable to be cut by the cable cutter of FIG. 1; and

FIGS. 3-6 show the cutting blades of the cable cutter of FIG. 1, progressively cutting through the cable of FIG. 2.

### DETAILED DESCRIPTION OF THE ILLUSTRATED EMBODIMENT

While this invention may be susceptible to embodiment in different forms, there is shown in the drawings and will be described herein in detail, a specific embodiment with the understanding that the present disclosure is to be considered an exemplification of the principles of the invention, and is not intended to limit the invention to that as illustrated and described herein.

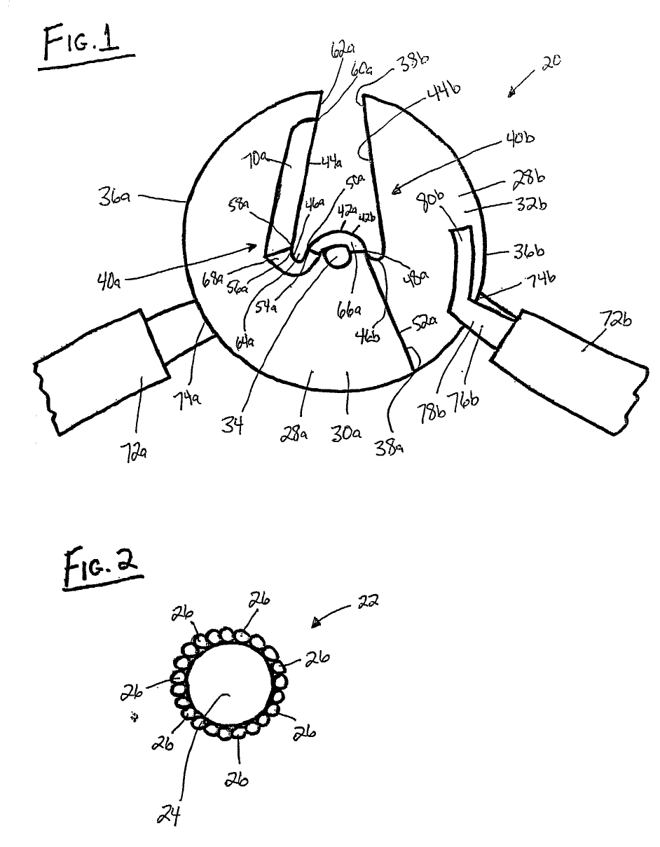

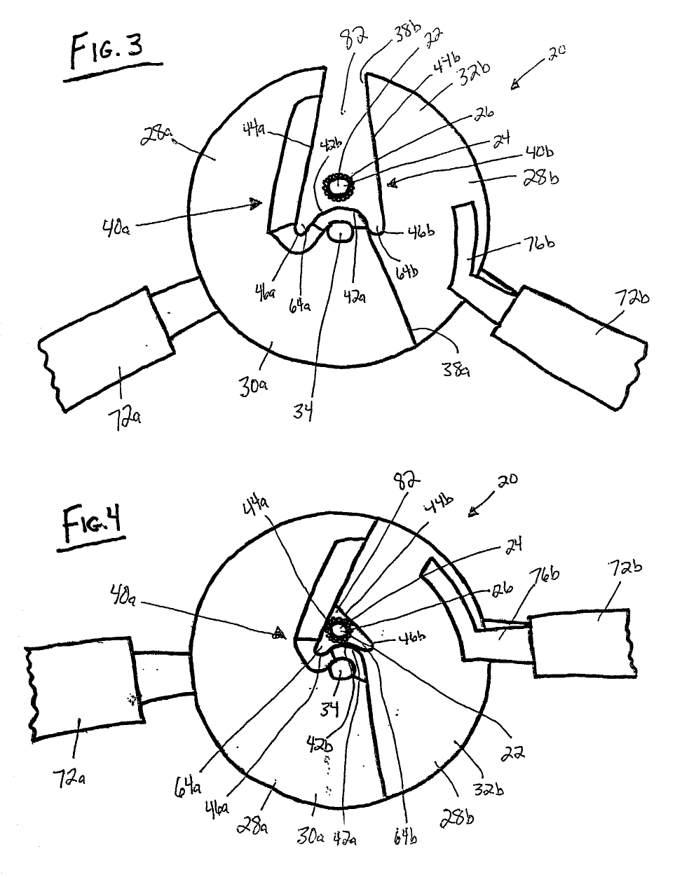

A tool 20 which is used to cut a workpiece 22, such as cable, is provided and is illustrated in FIG. 1. The tool 20 is preferably used to cut aluminum cable steel reinforced (“ACSR”) cable 22, which is illustrated in FIG. 2, but can also be used to cut cables made of soft material, such as aluminum or copper, or cables of hard material, such as steel.

As shown in FIG. 2, ACSR cable 22 typically includes a single strand center core 24 formed of steel and an outer stranded cable configuration 26 formed of a plurality of strands of aluminum. The harder central steel core 24 is used as a reinforcing strand providing structural stability to the cable 22. The outer aluminum stranded configuration 26 serves as the electrically conductive portion. It should be noted that another form of the ACSR cable (not shown) could have multiple steel cores surrounded by the outer aluminum stranded configuration.

The tool 20 includes a first jaw or blade member 28a and a second jaw or blade member 28b. The first and second blade members 28a, 28b are identical to one another. The first blade member 28a has an outer surface 30a and an inner surface (not shown). The second blade member 28b has an outer surface (not shown) and an inner surface 32b. The inner surface of the first blade member 28a is in opposing relation to the inner surface 32b of the second blade member 28b and the blade members 28a, 28b are connected to one another by appropriate means about a pivot 34 such that the blade members 28a, 28b can be rotated relative to one another. The blade members 28a, 28b are offset from one another. The inner and outer surfaces 32b, 30a of the blade members 28a, 28b are generally planar.

Each blade member 28a, 28b has an outer edge 36a, 36b which is arcuate. Each blade member 28a, 28b has an inner edge 38a, 38b which extends from the respective outer edge 36a, 36b generally toward the pivot 34, extends generally around the pivot 34, and then extends back to the respective outer edge 36a, 36b.

As best illustrated in FIG. 1, the first blade member 28a includes a cutting configuration 40a provided along a portion of the inner edge 38a. The cutting configuration 40a includes a first sharp edge 42a, a second sharp edge 44a and a blunt flat edge 46a provided between the first and second sharp edges 42a, 44a. It should be noted that the second blade member 28b also includes a cutting configuration 40b identical to that of the first blade member 28a. Thus, it is to be understood that the structure described in connection with the cutting configuration 40a of the first blade member 28a is also provided on the cutting configuration 40b of the second blade member 28b. It should further be noted that the cutting configurations 40a of the blade members 28a, 28b are provided in opposing relation to one another.

The first sharp edge 42a is provided proximate to the pivot 34 such that the first sharp edge 42a curves around the pivot 34 in a convex manner, as illustrated in FIG. 1. The first sharp edge 42a has a first end 48a and a second end 50a. The first end 48a of the first sharp edge 42a also forms an end of the cutting configuration 40a. From the first end 48a of the first sharp edge 42a, a portion 52a of the inner edge 38a extends straight to the outer edge 36a.

The blunt edge 46a has a first end 54a and a second end 56a. The first end 54a of the blunt edge 46a is connected to the second end 50a of the first sharp edge 42a such that the blunt edge 46a extends therefrom. The blunt edge 46a curves in a concave manner, as illustrated in FIG. 1, from the first sharp edge 42a.

The second sharp edge 44a has a first end 58a and a second end 60a and is generally straight. The first end 58a of the second sharp edge 44a is connected to the second end 56a of the blunt edge 46a such that the second sharp edge 44a extends therefrom. The second sharp edge 44a extends from the blunt edge 46a toward, but does not extend to, the outer edge 36a generally in the opposite direction as the portion 52a of the inner edge 38a extends from the first sharp edge 42a to the outer edge 36a. A portion 62a of the inner edge 38a extends straight from the second end 60a of the second sharp edge 44a to the outer edge 36a.

The concavity of the blunt edge 46a relative to the first and second sharp edges 42a, 44a defines a recess or pocket 64a proximate to the cutting configuration 40a of the first blade member 28a.

The first and second sharp edges 42a, 44a and the blunt edge 46a have a beveled side 66a, 68a, 70a, respectively, which extend from the inner edge 38a of the first blade member 28a to the outer planar surface 30a of the first blade member 28a. The beveled sides of the second blade member 28b are not shown in the drawings because the outer planar surface of the second blade member 28b is not illustrated.

First and second elongated levers or handles 72a, 72b are connected to the first and second blade members 28a, 28b, respectively. The handles 72a, 72b may have a gripping material (not shown) wrapped at least partially therearound such that a user's hand can easily grip the handles 72a, 72b. The length of the handles 72a, 72b may be varied as desired. An end 74a, 74b of each handle 40a, 40b is connected to the respective outer edge 36a, 36b of the blade member 28a, 28b, opposite the inner edges 38a, 38b, as illustrated in FIG. 1, in an appropriate manner known within the art, such as by welding.

As illustrated in FIG. 1, a guide member 76b extends from the handle 72b proximate to the end 74b thereof. The guide member 76b is generally L-shaped such that a first portion 78b thereof extends parallel to the handle 72b and a second portion 80b extends generally perpendicularly from the first portion 78b along the curvature of the outer edge 36b of the second blade member 28b. The guide member 76b is offset from the inner surface 32b of the second blade member 28b such that a space (not shown), which must be large enough to accommodate the first blade member 28a, is provided between the inner surface 32b of the second blade member 28b and the guide member 76b. The handle 72a has a guide member which extends therefrom in an identical manner to the guide member 76b of the handle 72b, but which is not illustrated in the drawings.

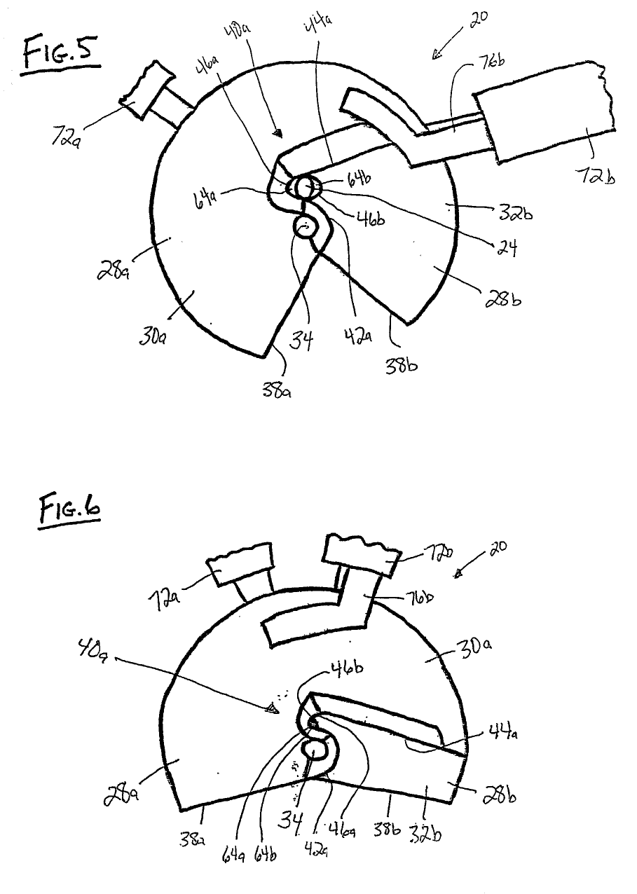

Operation of the tool 20 will now be discussed with reference to FIGS. 3-6. As illustrated in FIG. 3, the blade members 28a, 28b are rotated about the pivot 34 such that a gap 82 is provided between the cutting configurations 40a, 40b of the first and second blade members 28a, 28b. The cable 22 is then positioned within the gap 82, between the cutting configurations 40a, 40b.

Upon movement of the handles 72a, 72b, as in FIG. 4, with handle 72a moving clockwise and handle 72b moving counter-clockwise as shown in FIG. 4, the blade members 28a, 28b to rotate relative to one another about the pivot 34. The rotation of the blade members 28a, 28b causes the cutting configurations 40a, 40b to move toward one another such that the first and second sharp edges 42a, 42b; 44a, 44b of the blade members 28a, 28b come into contact with the outer aluminum stranded configuration 26 of the ACSR cable 22.

As illustrated in FIG. 5, continued movement of the handles 72a, 72b in the same direction causes the blade members 28a, 28b to continue to rotate relative to one another about the pivot 34. The continued rotation of the blade members 28a, 28b causes the first and second sharp edges 42a, 42b; 44a, 44b of the blade members 28a, 28b to cut through the outer aluminum stranded configuration 26 of the ACSR cable 22 and causes the harder central steel core 24 of the ACSR cable 22 to be moved into the pockets 64a, 64b defined by the cutting configurations 40a, 40b. As the blade members 28a, 28b cut through the outer aluminum stranded configuration 26 of the ACSR cable 22, the pockets 64a, 64b move into alignment with one another such that the pockets 64a, 64b are in communication with one another. The blunt edges 46a, 46b of the cutting configurations 40a, 40b of the blade members 28a, 28b are curved to have a small radius to nearly match a diameter of the harder central steel core 24 of the ACSR cable 22, thus entrapping the harder central steel core 24 in near perfect circle. The guide member 76b on the second handle 72b moves over the outer surface 30a of the first blade member 28a. Similarly, although not illustrated in the drawings, the guide member on the first handle 72a moves over the outer surface of the second blade member 28b.

Continued upward movement of the handles 72a, 72b in the same direction, as illustrated in FIG. 6, causes the blade members 28a, 28b to continue to rotate relative to one another about the pivot 34. The continued movement of the blade members 28a, 28b forces the blunt edges 46a of the cutting configurations 40a of the blade members 28a, 28b to shear the harder central steel core 24 of the ACSR cable 22, thus completely cutting through the ACSR cable 22. The guide member 76b continues to move over the outer surface 30a of the first blade member 28a. Similarly, although not illustrated in the drawings, the guide member on the first handle 72a continues to move over the outer surface of the second blade member 28b.

The handles 72a, 72b can then be moved in the opposite direction to the position illustrated in FIGS. 1 and 3 to allow for the cutting of another workpiece 22.

It should be noted that instead of providing the handles 72a, 72b of the tool 20 to perform the rotation of the blade members 28a, 28b toward one another in order to cut through the ACSR cable 22, the tool could be provided with other mechanisms to accomplish the same purpose, such as a ratchet and pawl, a hydraulic ram and hydraulic pump, and a driven pinion and gear mechanism.

It should also be noted that the tool 20 could be used to cut many different types of workpieces other than ACSR cable 22 as the sharp edges 42a, 44a of the tool 20 can effectively and efficiently cut through material which is generally soft in nature, such as aluminum or copper, while the blunt edges 46a of the tool 20 can effectively and efficiently cut through material which is generally hard in nature, such as steel.

The cutting configurations 40a of the blade members 28a, 28b provides for an improved cutting configuration for cutting ACSR cable 22 efficiently and effectively using manual force, in comparison to prior art cutters, in that the outer aluminum stranded configuration 26 need not be cut at the same time as the harder central steel core 24 is cut, which would require additional force. Additionally, the harder central steel core 24 is not cut by the sharp edges 42a, 44a of the blade members 28a, 28b, which are designed to cut the softer outer aluminum stranded configuration 26, thus preventing the dulling of the sharp edges 42a, 44a of the blade members 28a, 28b which reduces the wear life of the sharp edges 42a, 44a.

While a preferred embodiment of the present invention is shown and described, it is envisioned that those skilled in the art may devise various modifications of the present invention without departing from the spirit and scope of the appended claims.

The invention is claimed as follows:

1. A tool for cutting cable comprising:
first and second blades which are offset from one another and are pivotally connected along a common pivot, each said blade having an inner and outer edge, each said blade having a cutting configuration provided along a portion of said inner edges thereof which are in opposing relation to one another and which define a gap for accommodating the cable therebetween when said blades are partially closed, each said cutting configuration including, in series,
a first edge portion formed around a portion of said pivot,
a second edge portion which extends from said first edge portion and defines a recess, and
a third edge portion which extends from said second edge portion toward said outer edge.

2. A tool as defined in claim 1, wherein said first and third edge portions of each said blade are sharp.

3. A tool as defined in claim 1, wherein said second edge portion of each said blade is a blunt and flat.

4. A tool as defined in claim 3, wherein said second edge portion of each said blade is curved to have a generally small radius.

5. A tool as defined in claim 1, wherein each said blade has an inner surface and an outer surface, said inner surfaces of each said blade facing each other and being generally planar, said cutting configurations being defined by beveled surfaces extending from said inner edges to said outer surfaces.

6. A tool as defined in claim 1, further including a pair of handles, one of said handles being attached to one of said blades proximate to said outer edge thereof, said other one of said handles being attached to said other one of said blades proximate to said outer edge thereof, said handles capable of rotating said cutting configurations of each said blade toward one another and closing said gap therebetween upon movement of said handles.

7. A tool as defined in claim 6, further including a guide member which extends from each said handle proximate to said outer edge of each said blade, each said guide member extending over an outer surface of each said blade to define a space therebetween.

8. A tool as defined in claim 1, wherein said first edge portion curves in a first direction around said portion of said pivot, and wherein said second edge portion curves in a second direction which is opposite of said first direction.

9. A tool as defined in claim 1, wherein said recess defined by said second edge portion is concave.

10. A tool as defined in claim 1, wherein said third edge portion extends from said second edge portion straight toward said outer edge.

11. A cable cutting tool comprising:
a pair of blades having facing cutting configurations, said blades being connected at a pivot and defining therebetween a cable receiving gap;
said blades being movable toward one another to reduce a size of said gap to sever a cable held within said gap; and
each said cutting configuration formed to have a pair of sharp edge portions and a blunt edge portion.

12. A tool as defined in claim 11, wherein said blunt edge portion is provided between said pair of sharp edge portions on each said cutting configuration.

13. A tool as defined in claim 12, wherein on each said cutting configuration one of said sharp edge portions curves in a first direction around a portion of said pivot, said blunt edge portion extends from said one sharp edge portion and curves in a second direction which is opposite of said first direction, and said other one of said sharp edge portions extends straight from said blunt edge portion away from said pivot.

14. A tool as defined in claim 13, wherein on each said cutting configuration said blunt edge portion defines a concave recess within said cable receiving gap, said concave recess being sized to receive a portion of the cable.

15. A tool as defined in claim 11, further including a pair of handles, one of said handles being attached to one of said blades, said other one of said handles being attached to said other one of said blades, said handles capable of moving said blades toward one another to reduce the size of said gap to sever the cable.

16. A method of cutting cable comprising the steps of:
a) providing a tool having first and second blades which are offset from one another and are pivotally connected along a common pivot, each said blade having inner and outer edges, each said blade having a cutting configuration provided along a portion of said inner edges thereof which are in opposing relation to one another, each said cutting configuration including, in series, a first edge portion formed around a portion of said pivot, a second edge portion which extends from said first edge portion and defines a recess, and a third edge portion which extends from said second edge portion toward said outer edge;
b) providing the cable which has a first portion and a second portion wrapped around said first portion;
c) placing the cable between said opposing first and third edge portions;
d) moving said blades toward one another such that said opposing first and third edge portions cut through said second portion of said cable;
e) moving said blades toward one another to move said first portion of said cable into said recesses; and
f) moving said blades toward one another such that said opposing second edge portions shear through said first portion of said cable.

17. A method as defined in claim 16, further including the steps of:
a) providing a pair of handles, one of said handles being connected to one of said blades, said other one of said handles being connected to said other one of said blades
b) moving said handles to move said blades toward one another such that said opposing first and third edge portions cut through said second portion of said cable;
c) moving said handles to move said blades toward one another to move said first portion of said cable into said recesses; and
d) moving said handles to move said blades toward one another such that said opposing second edge portions shear through said first portion of said cable.

18. A method of cutting cable comprising the steps of:
a) providing a tool having first and second blades which are offset from one another and are pivotally connected along a common pivot, each said blade having inner and outer edges, each said blade having a cutting configuration provided along a portion of said inner edges thereof which are in opposing relation to one another, each said cutting configuration including, in series, a first sharp edge portion which curves in a first direction around a portion of said pivot, a blunt flat edge portion which extends from said first sharp edge portion and curves in a second direction which is opposite of said first direction to define a concave recess, and a second sharp edge portion which extends from said blunt flat edge portion straight toward said outer edge;
b) providing said cable which has an inner circular core and an outer circular configuration surrounding said core, said core being formed of material having a hardness greater than a material of said outer circular configuration;
c) placing the cable between said opposing sharp edge portions;
d) moving said blades toward one another such that said opposing sharp edge portions cut through said outer circular configuration of said cable;
e) moving said blades toward one another to force said inner circular core of said cable into said concave recesses; and
f) moving said blades toward one another such that said opposing blunt edge portions shear through said inner circular core of said cable.

19. A method as defined in claim 18, further including the steps of:
a) providing a pair of handles, one of said handles being connected to one of said blades, said other one of said handles being connected to said other one of said blades;
b) moving said handles to move said blades toward one another such that said opposing sharp edge portions cut through said outer circular configuration of said cable;
c) moving said handles to move said blades toward one another to force said inner circular core of said cable into said concave recesses; and
d) moving said handles to move said blades toward one another such that said opposing blunt edge portions shear through said inner circular core of said cable.
